(19) United States
(12) Patent Application Publication
(10) Pub. No.: US 2024/0131791 A1
(43) Pub. Date: Apr. 25, 2024

(54) Three-Dimensional Shaping Device

(71) Applicant: SEIKO EPSON CORPORATION, Tokyo (JP)

(72) Inventors: Manabu WATANABE, Shiojiri (JP); Makoto OMURA, Matsumoto (JP)

(21) Appl. No.: 18/492,868

(22) Filed: Oct. 23, 2023

(30) Foreign Application Priority Data
Oct. 24, 2022 (JP) 2022-170371

(51) Int. Cl. B29C 64/336; B29C 64/393

(52) U.S. Cl. CPC B29C 64/336; B29C 64/393; B33Y 30/00

(57) ABSTRACT

A three-dimensional shaping device includes a stage, an ejection portion configured to selectively eject, as a shaping material, a first material containing a crystalline resin and a second material containing an amorphous resin to an upper side of the stage, a moving portion configured to relatively move the stage and the ejection portion, and a control unit. The control unit executes first stacking processing when a plurality of slice layers are stacked using the first material as the shaping material and executes second stacking processing when a plurality of slice layers are stacked using the second material as the shaping material. The first stacking processing includes first slice layer forming processing, first ejection stop processing, first temperature detection processing, and second slice layer forming processing, and the second stacking processing includes third slice layer forming processing, second ejection stop processing, first determination processing, and fourth slice layer forming processing.

The present application is based on, and claims priority from JP Application Serial Number 2022-170371, filed Oct. 25, 2022, the disclosure of which is hereby incorporated by reference herein in its entirety.

### BACKGROUND

### 1. Technical Field

The present disclosure relates to a three-dimensional shaping device.

### 2. Related Art

Research and development have been conducted on a three-dimensional shaping device that shapes a three-dimensional shaped object by stacking a shaping material at least partially melted.

Related to such a three-dimensional shaping device, JP-A-2022-100657 discloses a three-dimensional shaping device that includes a stage, an ejection portion that ejects a molten material toward the stage, a position changing portion that changes a relative position of the stage and the ejection portion, a temperature adjusting portion that adjusts a temperature of the material ejected to the stage, a temperature sensor that measures the temperature of the material ejected to the stage, a storage unit that stores first relational data representing a relationship between the temperature of the material and a viscosity of the material, and a control unit that controls the ejection portion, the position changing portion, and the temperature adjusting portion so as to form a first shaped object and a second shaped object on the stage. The control unit executes first control for shaping the first shaped object by ejecting the material from the ejection portion, second control for adjusting an output of the temperature adjusting portion while measuring a temperature of the first shaped object by the temperature sensor so that a viscosity of the first shaped object calculated based on the temperature of the first shaped object measured by the temperature sensor and the first relational data becomes a predetermined viscosity or less, third control for forming a first portion of the second shaped object by ejecting the material from the ejection portion, and fourth control for forming a second portion that is a portion adjacent to the first portion of the second shaped object by ejecting the material from the ejection portion while adjusting a temperature of the first portion by the temperature adjusting portion with the output adjusted in the second control.

With such a configuration, the three-dimensional shaping device disclosed in JP-A-2022-100657 can prevent deformation of a shaped object when the shaped object is stacked on another shaped object while preventing adhesion between the shaped objects from being lowered. However, a lowering speed of a temperature of the shaped object is determined according to a type of the material ejected from the ejection portion and a shape of the three-dimensional shaped object. Therefore, in the three-dimensional shaping device, a cycle time may be unlimitedly increased depending on the type of the material ejected as a shaped object and the shape of the three-dimensional shaped object to be shaped.

### SUMMARY

In order to solve the above problems, according to an aspect of the present disclosure, there is provided a three-dimensional shaping device that stacks a plurality of slice layers as a three-dimensional shaped object having a predetermined shape. The three-dimensional shaping device includes: a stage; an ejection portion configured to selectively eject, as a shaping material, a first material containing a crystalline resin and a second material containing an amorphous resin to an upper side of the stage; a moving portion configured to relatively move the stage and the ejection portion; and a control unit configured to control the ejection portion and the moving portion, in which the control unit executes first stacking processing when the plurality of slice layers are stacked as the three-dimensional shaped object using the first material as the shaping material without using the second material, and executes second stacking processing when the plurality of slice layers are stacked as the three-dimensional shaped object using the second material as the shaping material without using the first material, the first stacking processing includes first slice layer forming processing of controlling the ejection portion and the moving portion and stacking an (n−1)-th slice layer among the plurality of slice layers to the upper side of the stage, first ejection stop processing of causing the ejection portion to stop ejection of the shaping material after the first slice layer forming processing is completed, first temperature detection processing of causing a temperature detection portion to detect a temperature of a measurement region of the (n−1)-th slice layer after the first ejection stop processing is completed, and second slice layer forming processing of controlling the ejection portion and the moving portion and stacking an n-th slice layer among the plurality of slice layers to the upper side of the stage when the temperature detected by the temperature detection portion in the first temperature detection processing is equal to or less than a predetermined threshold, the second stacking processing includes third slice layer forming processing of controlling the ejection portion and the moving portion and stacking the (n−1)-th slice layer to the upper side of the stage, second ejection stop processing of causing the ejection portion to stop ejection of the shaping material after the third slice layer forming processing is completed, first determination processing of determining whether a predetermined standby time is elapsed from a first timing corresponding to a stop of the ejection of the shaping material from the ejection portion by the second ejection stop processing, and fourth slice layer forming processing of controlling the ejection portion and the moving portion and stacking the n-th slice layer to the upper side of the stage when it is determined in the first determination processing that the standby time is elapsed from the first timing, and n is an integer of 2 or more.

### BRIEF DESCRIPTION OF THE DRAWINGS

FIG. 1 is a diagram illustrating an example of a configuration of a three-dimensional shaping device 1.

FIG. 2 is a diagram illustrating an example of a predetermined measurement region in an n-th slice layer Ln.

FIG. 3 is a diagram illustrating an example of a hardware configuration of a control device 60.

FIG. 4 is a diagram illustrating an example of a functional configuration of the control device 60.

FIG. 5 is a diagram illustrating an example of a flow of processing in which the control device 60 executes shaping control.

FIG. 6 is a diagram illustrating an example of a flow of first stacking processing executed in step S160 illustrated in FIG. 5.

FIG. 7 is a diagram illustrating an example of a flow of second stacking processing executed in step S180 illustrated in FIG. 5.

FIG. 8 is a diagram illustrating an example of a flow of mixed stacking processing executed in step S210 illustrated in FIG. 5.

FIG. 9 is a diagram illustrating an example of a flow of third stacking processing executed in step S213 illustrated in FIG. 8.

FIG. 10 is a diagram illustrating an example of a flow of fourth stacking processing executed in step S214 illustrated in FIG. 8.

FIG. 11 is a diagram illustrating an example of a flow of predicted end time calculation processing executed by the control device 60.

### DESCRIPTION OF EMBODIMENTS

### Embodiment

Hereinafter, an embodiment of the present disclosure will be described with reference to the drawings.

### Overview of Three-Dimensional Shaping Device

First, an overview of a three-dimensional shaping device according to the embodiment will be described.

The three-dimensional shaping device according to the embodiment stacks a plurality of slice layers as a three-dimensional shaped object having a predetermined shape. The three-dimensional shaping device includes a stage, an ejection portion, a moving portion, and a control unit. The ejection portion selectively ejects, as a shaping material, a first material containing a crystalline resin and a second material containing an amorphous resin to an upper side of the stage. The moving portion moves the stage and the ejection portion relative to each other. The control unit controls the ejection portion and the moving portion. When a plurality of slice layers are stacked as a three-dimensional shaped object using the first material without using the second material as the shaping material, the control unit executes first stacking processing, and when a plurality of slice layers are stacked as a three-dimensional shaped object using the second material without using the first material as the shaping material, the control unit executes second stacking processing. Here, the first stacking processing includes first slice layer forming processing, first ejection stop processing, first temperature detection processing, and second slice layer forming processing. The first slice layer forming processing is processing of controlling the ejection portion and the moving portion and stacking an (n−1)-th slice layer among the plurality of slice layers to the upper side of the stage. The first ejection stop processing is processing of causing the ejection portion to stop the ejection of the shaping material after the first slice layer forming processing is completed. The first temperature detection processing is processing of causing a detection portion to detect a temperature of a measurement region of the (n−1)-th slice layer after the first ejection stop processing is completed. The second slice layer forming processing is processing of controlling the ejection portion and the moving portion and stacking an n-th slice layer among the plurality of slice layers to the upper side of the stage when the temperature detected by the detection portion in the first temperature detection processing is equal to or lower than a predetermined threshold. The second stacking processing includes third slice layer forming processing, second ejection stop processing, first determination processing, and fourth slice layer forming processing. The third slice layer forming processing is processing of controlling the ejection portion and the moving portion and stacking the (n−1)-th slice layer to the upper side of the stage. The second ejection stop processing is processing of causing the ejection portion to stop the ejection of the shaping material after the third slice layer forming processing is completed. The first determination processing is processing of determining whether a predetermined standby time is elapsed from a first timing corresponding to the stop of the ejection of the shaping material from the ejection portion in the second ejection stop processing. The fourth slice layer forming processing is processing of controlling the ejection portion and the moving portion and stacking the n-th slice layer to the upper side of the stage when it is determined in the first determination processing that the standby time is elapsed from the first timing. n is an integer of 2 or more. Accordingly, the three-dimensional shaping device can prevent an increase in a cycle time while preventing a decrease in interlayer adhesion.

Hereinafter, a configuration of the three-dimensional shaping device according to the embodiment, a configuration of a control device provided in the three-dimensional shaping device, and processing executed by the control device will be described in detail.

### Configuration of Three-Dimensional Shaping Device

Hereinafter, a configuration of the three-dimensional shaping device according to the embodiment will be described by taking a three-dimensional shaping device 1 as an example.

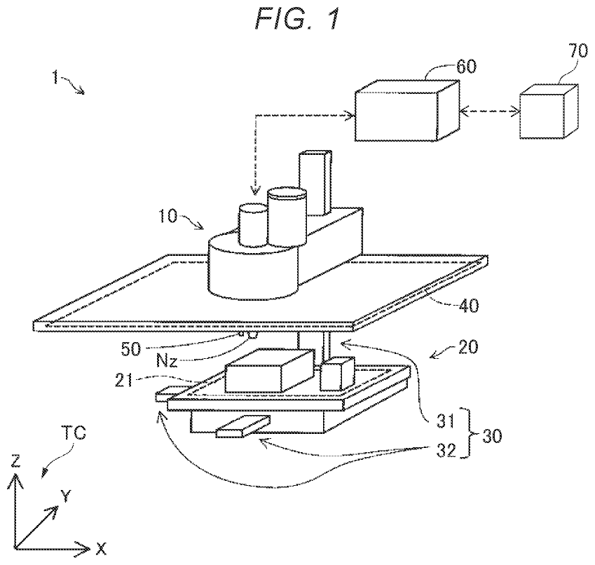

FIG. 1 is a diagram illustrating an example of a configuration of the three-dimensional shaping device 1.

Here, a three-dimensional coordinate system TC is a three-dimensional orthogonal coordinate system indicating directions in which the three-dimensional coordinate system TC is drawn. Hereinafter, an X axis in the three-dimensional coordinate system TC is simply referred to as an X axis for the convenience of description. Hereinafter, a Y axis in the three-dimensional coordinate system TC is simply referred to as a Y axis for the convenience of description. Hereinafter, a Z axis in the three-dimensional coordinate system TC is simply referred to as a Z axis for the convenience of description. Hereinafter, a case where a negative direction of the Z axis coincides with the direction of gravity will be described as an example. Therefore, in the following description, a positive direction of the Z axis is simply referred to as an up direction or up, and the negative direction of the Z axis is simply referred to as a down direction or down for the convenience of description.

The three-dimensional shaping device 1 includes an ejection portion 10 having a nozzle Nz, a stage 20 having a shaping surface 21 on which a three-dimensional shaped object is to be shaped, a moving portion 30, a heating portion 40, a temperature detection portion 50, a control device 60, and a data generation device 70. In the three-dimensional shaping device 1, the control device 60 may be integrated with the data generation device 70. The three-dimensional shaping device 1 may not include the data generation device 70. In this case, the data generation device 70 is communicably connected to the control device 60 of the three-dimensional shaping device 1 from the outside. The three-dimensional shaping device 1 may not include the control device 60 and the data generation device 70. In this case, the control device 60 is communicably connected to the three-dimensional shaping device 1 from the outside. In this case, the data generation device 70 is communicably connected to the control device 60 from the outside.

The three-dimensional shaping device 1 changes a relative position between the ejection portion 10 and the stage 20 while ejecting a shaping material X (not illustrated) from the ejection portion 10 toward the shaping surface 21 of the stage 20. Accordingly, the three-dimensional shaping device 1 shapes one three-dimensional shaped object having a predetermined shape by stacking N slice layers L. Here, N may be any integer of 1 or more. In this case, a first slice layer L counted from the bottom of the N slice layers L is stacked on the shaping surface 21. Each of the N slice layers L stacked on the shaping surface 21 is the shaping material X ejected along a shaping path parallel to the shaping surface 21. The shaping path is a scanning path with respect to the stage 20 where the nozzle Nz moves while ejecting the shaping material X. That is, the three-dimensional shaping device 1 causes the ejection portion 10 to eject the shaping material X along a shaping path of an n-th slice layer L among the N slice layers L, and stacks the n-th slice layer L on an (n−1)-th slice layer L(n−1). n is an integer of 1 or more and N or less. Each of the N slice layers L may be formed of a single layer or a plurality of stacked layers. Here, a shaping path of a slice layer L includes an outline path which is a scanning path of the nozzle Nz along an outline of the slice layer L and an infill path which is a scanning path of the nozzle Nz in a region surrounded by the outline path. That is, the slice layer L includes the shaping material X ejected along the outline path of the slice layer L and the shaping material X ejected along the infill path of the slice layer L.

The three-dimensional shaping device 1 can selectively eject two types of materials, that is, a first material and a second material having different characteristics, as the shaping material X from the nozzle Nz. Accordingly, the three-dimensional shaping device 1 can shape a three-dimensional shaped object shaped using at least one of the two types of materials. Here, the first material is a material containing a crystalline resin. The second material is a material containing an amorphous resin. Hereinafter, a case where the crystalline resin is polyoxymethylene (POM) will be described as an example. Instead of POM, the crystalline resin may be other types of crystalline resin such as polyamide 12 (PA 12), polybutylene terephthalate (PBT), polysulfone (PSU), polyamide 66 (PA 66), polyethylene terephthalate (PET), liquid crystal polymer (LCP), polyether ether ketone (PEEK), polysulfone (PSF), polyamide 6 (PA 6), or polyphenylene sulfide (PPS). Hereinafter, a case where the amorphous resin is acrylonitrile butadiene styrene (ABS) will be described as an example. The amorphous resin may be other types of amorphous resin instead of ABS.

The three-dimensional shaping device 1 executes shaping control for shaping such a three-dimensional shaped object based on three-dimensional shaping data. Here, the three-dimensional shaping device 1 generates three-dimensional shaping data in response to a received operation. The three-dimensional shaping data is data for causing the three-dimensional shaping device 1 to stack the N slice layers L as a three-dimensional shaped object having a predetermined shape. The three-dimensional shaping device 1 stores shape data indicating the shape. For example, the shape data may be any data as long as the shape data is data indicating the shape, and is, for example, stereolithography (STL) data. Based on a received operation and the shape data, the three-dimensional shaping device 1 generates object data indicating a virtual object including at least a shaped body of a virtual shaped body having a shape indicated by the shape data and a virtual support body added to the shaped body to support the shaped body. The shaped body is a portion that is separated from the N slice layers L as one three-dimensional shaped object among portions of the stacked N slice layers L. The support body is a portion that supports the shaped body among the portions of the stacked N slice layers L.

After the object data is generated, the three-dimensional shaping device 1 stores the generated object data. After the object data is stored, the three-dimensional shaping device 1 virtually slices the object into N slice layers VL based on slice condition information. The N slice layers VL obtained by virtually slicing the object by the three-dimensional shaping device 1 correspond to the N slice layers L described above. Hereinafter, for the convenience of description, an n-th slice layer VL of the N slice layers VL is referred to as a slice layer VLn, and the n-th slice layer L of the N slice layers L is referred to as a slice layer Ln. In this case, for example, the first slice layer VL1 corresponds to the first slice layer L1. The slice condition information is information indicating a slice condition for virtually slicing an object indicated by the object data stored in the three-dimensional shaping device 1 into the N slice layers VL. The slice condition information includes, as information indicating the slice condition, information such as information indicating the number of the N slice layers VL and information indicating thicknesses of the N slice layers VL.

After the object is virtually sliced, the three-dimensional shaping device 1 generates a shaping path of a slice layer VL for each of the sliced N slice layers VL based on shaping path generation condition information. As described above, the shaping path is a scanning path with respect to the stage 20 where the nozzle Nz moves while ejecting the shaping material X. Therefore, the shaping material X ejected along the shaping path of the n-th slice layer VLn is the actual slice layer Ln corresponding to the slice layer VLn.

Here, the n-th slice layer VLn is one of the slice layers obtained by slicing at least one of the shaped body and the support body included in the object. Therefore, the n-th slice layer VLn includes at least one of a portion obtained by slicing the shaped body and a portion obtained by slicing the support body. A portion obtained by slicing the shaped body among portions included in the n-th slice layer VLn is, in other words, a shaped region included in the shaped body among regions included in the n-th slice layer VLn. A portion obtained by slicing the support body among the portions included in the n-th slice layer VLn is, in other words, a support region included in the support body among the regions included in the n-th slice layer VLn. That is, the n-th slice layer VLn includes at least one of a layer of the shaped body region and a layer of the support body region. Layers of the shaped region are classified into two types of a first solid layer and a shaped layer. The first solid layer is a solid layer of the shaped body. The shaped body includes the first solid layer and the shaped layer stacked between the first solid layers and the first solid layer. That is, the shaped body is shaped by stacking the first solid layer and the shaped layer. Layers of the support region are classified into three types of a second solid layer, a support layer, and a raft layer. The second solid layer is a solid layer of the support body. The raft layer is a base layer on which the first solid layer, the shaped layer, the second solid layer, and the support layer are stacked. The support body includes the second solid layer, the support layer stacked between the second solid layer and the second solid layer, and the raft layer. That is, the support body is formed by stacking the second solid layer, the support layer, and the raft layer. For example, when a shape of a certain shaped body is a shape having an overhang, the overhang portion of a portion of the shaped body is supported by such a support body. From the above, types of the n-th slice layer VLn are classified according to a layer included in the n-th slice layer VLn. For example, when the n-th slice layer VLn includes only the first solid layer, the type of the n-th slice layer VLn is the first solid layer. For example, when the n-th slice layer VLn includes the first solid layer and the second solid layer, the type of the n-th slice layer VLn is represented by a combination of a type of a layer obtained by slicing the shaped body among layers included in the n-th slice layer VLn and a type of a layer obtained by slicing the support body among the layers included in the n-th slice layer VLn, that is, a combination of the first solid layer and the second solid layer. The type of the n-th slice layer VLn is also the type of the n-th slice layer Ln. Therefore, the three-dimensional shaping device 1 can specify the type of the n-th slice layer VLn and the type of the slice layer Ln based on the slice condition information.

Hereinafter, for the convenience of description, one or more slice layers VL including the shaped region and not including the support region among the N slice layers VL are referred to as shaped body slice layers. Hereinafter, for the convenience of description, one or more slice layers VL including the shaped region and including the support region among the N slice layers VL are referred to as mixed slice layers. Hereinafter, for the convenience of description, one or more slice layers VL not including the shaped region and including the support region among the N slice layers VL are referred to as support body slice layers. The N slice layers VL may or may not include the support body slice layer.

After a shaping path of each of the N slice layers VL is generated, the three-dimensional shaping device 1 generates three-dimensional shaping data including shaping path information indicating the generated shaping path of each of the N slice layers VL. Here, the shaping path generation condition information is information indicating a shaping path generation condition for generating a shaping path for each of the N slice layers VL. The shaping path generation condition information includes information such as information indicating a shape of a shaping path for each type of the N slice layers VL, information indicating a width of a shaping path for each type of the N slice layers VL, information indicating a thickness of a shaping path for each type of the N slice layers VL, information indicating a moving speed of the nozzle Nz when the shaping material X is ejected along a shaping path for each type of the N slice layers VL, and information indicating a type of the shaping material X ejected from the nozzle Nz. The shaping path information indicating a shaping path includes information such as information indicating a width of the shaping path, information indicating a thickness of the shaping path, and information indicating a moving speed of the nozzle Nz when the shaping material X is ejected along the shaping path.

In the three-dimensional shaping device 1, the slice condition information may or may not include (n−1)-th slice layer type information indicating a type of the (n−1)-th slice layer VL(n−1) among the N slice layers VL and n-th slice layer type information indicating a type of the n-th slice layer VLn stacked on the (n−1)-th slice layer VL(n−1) among the N slice layers VL.

Here, the slice layer L of the raft layer among the N slice layers L is a layer formed between the shaping surface 21 and another layer as a base of the slice layer L of the another layer, and is a layer filled with the shaping material X. The another layer is an individual slice layer L stacked on the raft layer among the N slice layers L, and specifically, is a part or all slice layers L of the first solid layer, the shaped layer, the second solid layer, and the support layer. When the another layer is stacked on the shaping surface 21 in a manner of being brought into contact with the shaping surface 21, the another layer may be hardly peeled off from the shaping surface 21. In this case, the another layer may be not fixed with high accuracy. In this case, residual stress may remain in the another layer. In order to solve this problem, a layer stacked between the another layer and the shaping surface 21 is the slice layer L of the raft layer. The slice layers L of the solid layer, the shaped layer, and the support layer are formed by an outline which is the shaping material X ejected along an outline of a predetermined outer shape and an infill which is the shaping material X ejected in a region surrounded by the outline. In other words, the slice layers L of the solid layer, the shaped layer, and the support layer are formed by the outline which is the shaping material X ejected along the outline path, and the infill which is the shaping material X ejected along the infill path. The slice layer L of the solid layer is a layer in which an inner side of a region surrounded by the outline of the slice layer L of the solid layer is filled with the infill with substantially no gap. In other words, the slice layer L of the solid layer is a layer in which a filling rate of the infill in the region is 100%. In other words, the slice layer L of the first solid layer is one or more layers including the shaping material X for forming a front surface of the shaped body. The slice layer L of the shaped layer is one or more layers including the shaping material X for forming an inner side of the shaped body. In other words, the slice layer L of the second solid layer is one or more layers including the shaping material X for forming a front surface of the support body. On the other hand, the slice layer L of the shaped layer is a layer in which an infill is included in a region surrounded by the outline of the shaped layer and a region not filled with the infill is present in the region. In other words, the slice layer L of the shaped layer is a layer in which a filling rate of the infill in the region is less than 100%. In other words, the slice layer L of the shaped layer is one or more layers including the shaping material X for forming an inner side of the shaped body. The slice layer L of the support layer is a layer in which an infill is included in a region surrounded by the outline of the support layer and a region not filled with the infill is present in the region. In other words, the slice layer L of the support layer is a layer in which a filling rate of the infill in the region is less than 100%. In other words, the slice layer Ln of the support layer is one or more layers including the shaping material X for forming an inner side of the support body.

The three-dimensional shaping device 1 executes shaping control for shaping a three-dimensional shaped object based on the three-dimensional shaping data generated as described above. When the N slice layers L are stacked on the shaping surface 21 in the shaping control, the three-dimensional shaping device 1 shapes one three-dimensional shaping object by causing the ejection portion 10 to eject the N slice layers L onto the shaping surface 21 as slice layers L of types represented by a part or all of the raft layer, the first solid layer, the shaped layer, the second solid layer, and the support layer, and stacking the N slice layers L.

Here, a three-dimensional shaping device Xl different from the three-dimensional shaping device 1 may detect a temperature of a stacked slice layer each time the slice layer is stacked to the upper side of the stage and is in standby until the detected temperature is equal to or lower than a predetermined threshold. This is processing for preventing a decrease in interlayer adhesion when a subsequent slice layer is stacked on a previously stacked slice layer, preventing deformation of the previously stacked slice layer, and preventing shaping accuracy of the three-dimensional shaped object from being lowered. A temperature lowing speed of a slice layer is determined depending on a type of a material ejected as the slice layer and a shape of a three-dimensional shaped object to be shaped. Therefore, in the three-dimensional shaping device Xl, a cycle time may be unlimitedly increased depending on the type of the material ejected as the slice layer and the shape of the three-dimensional shaped object.

In the shaping control for shaping a three-dimensional shaped object, the three-dimensional shaping device 1 executes the first stacking processing when the N slice layers L are stacked as a three-dimensional shaped object using the first material without using the second material as the shaping material X, and executes the second stacking processing when the N slice layers L are stacked as a three-dimensional shaped object using the second material without using the first material as the shaping material X. Here, the first stacking processing includes the first slice layer forming processing, the first ejection stop processing, the first temperature detection processing, and the second slice layer forming processing. The first slice layer forming processing is processing of controlling the ejection portion 10 and the moving portion 30 and stacking the (n−1)-th slice layer of the N slice layers to the upper side of the stage 20. The first ejection stop processing is processing of causing the ejection portion 10 to stop the ejection of the shaping material X after the first slice layer forming processing is completed. The first temperature detection processing is processing of causing the temperature detection portion 50 to detect a temperature of a measurement region of the (n−1)-th slice layer after the first ejection stop processing is completed. The second slice layer forming processing is processing of controlling the ejection portion 10 and the moving portion 30 and stacking the n-th slice layer L to the upper side of the stage 20 when the temperature detected by the temperature detection portion 50 in the first temperature detection processing is equal to or lower than a predetermined threshold TH. The second stacking processing includes the third slice layer forming processing, the second ejection stop processing, the first determination processing, and the fourth slice layer forming processing. The third slice layer forming processing is processing of controlling the ejection portion 10 and the moving portion 30 and stacking the (n−1)-th slice layer L(n−1) of the N slice layers to the upper side of the stage 20. The second ejection stop processing is processing of causing the ejection portion 10 to stop the ejection of the shaping material X after the third slice layer forming processing is completed. The first determination processing is processing of determining whether a predetermined standby time is elapsed from a first timing corresponding to the stop of the ejection of the shaping material X from the ejection portion 10 in the second ejection stop processing. The fourth slice layer forming processing is processing of controlling the ejection portion 10 and the moving portion 30 and stacking the n-th slice layer of the N slice layers to the upper side of the stage 20 when it is determined in the first determination processing that the standby time is elapsed from the first timing. Accordingly, the three-dimensional shaping device 1 can prevent an increase in a cycle time while preventing a decrease in interlayer adhesion.

The ejection portion 10 is an ejection device that selectively ejects the first material and the second material as the shaping material X onto the shaping surface 21. The ejection portion 10 includes two nozzles of a first nozzle and a second nozzle as the nozzle Nz. In addition to such a nozzle Nz, the ejection portion 10 includes a first material melting portion that melts one or more types of materials to form the first material, a second material melting portion that melts one or more types of materials to form the second material, a first material supply portion, and a second material supply portion. Here, in the ejection portion 10, the first material supply portion and the first material melting portion are coupled by a first supply path. In the ejection portion 10, the second material supply portion and the second material melting portion are coupled by a second supply path. The first material melting portion and the first nozzle are coupled by a first communication hole. The first material supplied from the first material melting portion through the first communication hole is ejected from a tip end of the first nozzle as the shaping material X. The second material melting portion and the second nozzle are coupled by a second communication hole. The second material supplied from the second material melting portion through the second communication hole is ejected from a tip end of the second nozzle as the shaping material X. The ejection portion 10 may have a configuration in which a single nozzle is provided as the nozzle Nz, instead of the configuration in which two nozzles of the first nozzle and the second nozzle are provided as the nozzle Nz. In this case, the ejection portion 10 includes a material supply switching portion in each of the nozzle Nz, the first material melting portion, the second material melting portion, the first material supply portion, and the second material supply portion. The material supply switching portion switches a material to be supplied as the shaping material X to the nozzle Nz via a communication hole between the first material supplied from the first material melting portion and the second material supplied from the second material melting portion. Here, in this case, the second material supply portion and the second material melting portion are coupled by the second supply path in the ejection portion 10. The first material melting portion and the material supply switching portion are coupled by a third supply path. The second material melting portion and the material supply switching portion are coupled by a fourth supply path. The material supply switching portion and the nozzle Nz are coupled by a communication hole. The shaping material X supplied from the material supply switching portion through the communication hole is ejected from a tip end of the nozzle Nz.

Here, when stacking the n-th slice layer Ln on the (n−1)-th slice layer L(n−1), the three-dimensional shaping device 1 changes at least one of a width of the shaping material X ejected onto an upper surface of the (n−1)-th slice layer L(n−1) and a thickness of the shaping material X ejected onto the upper surface of the (n−1)-th slice layer L(n−1) by changing a distance between the upper surface of the (n−1)-th slice layer L(n−1) and the tip end of the nozzle Nz. A maximum value of the width of the shaping material X ejected to the upper surface of the n-th slice layer Ln by the three-dimensional shaping device 1 is an outer diameter of the tip end of the nozzle Nz. This is because when the distance between the upper surface of the (n−1)-th slice layer L(n−1) and the tip end of the nozzle Nz is smaller than an inner diameter of the tip end of the nozzle Nz, the shaping material X ejected from the tip end of the nozzle Nz is ejected onto the upper surface of the (n−1)-th shaped layer while being crushed by the tip end of the nozzle Nz.

The first material supply portion accommodates one or more types of materials in a state of pellets, powder, or the like as a material to be formed as the first material. Hereinafter, a case where the material accommodated in the first material supply portion contains a pellet-shaped crystalline resin will be described as an example. The first material supply portion is implemented by, for example, a hopper. The material accommodated in the first material supply portion is supplied to the first material melting portion via the first supply path provided below the first material supply portion. The first material supply portion may be a first material reservoir and may be detachable from the three-dimensional shaping device 1. For example, such a first material reservoir has first identification information for identifying the shaping material X formed using the material stored in the first material reservoir. In this case, the three-dimensional shaping device 1 includes a first reading unit that reads the first identification information provided in the first material reservoir. Accordingly, the three-dimensional shaping device 1 can determine whether the shaping material X identified by the first identification information read by the first reading unit includes a crystalline resin. Here, the first identification information may be an encoded code such as a bar code or a two-dimensional bar code, or may be other types of information capable of identifying the shaping material X.

The second material supply portion accommodates one or more types of materials in a state of pellets, powder, or the like as a material to be formed as the second material. Hereinafter, a case where the material accommodated in the second material supply portion contains a pellet-shaped amorphous resin will be described as an example. The second material supply portion is implemented by, for example, a hopper. The material accommodated in the second material supply portion is supplied to the second material melting portion via the second supply path provided below the second material supply portion. The second material supply portion may be a second material reservoir, and may be detachable from the three-dimensional shaping device 1. For example, such a second material reservoir has second identification information for identifying the shaping material X formed using the material stored in the second material reservoir. In this case, the three-dimensional shaping device 1 includes a second reading unit that reads the second identification information provided in the second material reservoir. Accordingly, the three-dimensional shaping device 1 can determine whether the shaping material X identified by the second identification information read by the second reading unit includes a crystalline resin. Here, the second identification information may be an encoded code such as a bar code or a two-dimensional bar code, or may be other types of information capable of identifying the shaping material X.

The first material melting portion includes a screw case, a flat screw accommodated in the screw case, a drive motor that drives the flat screw, and a barrel fixed below the flat screw in the screw case.

The flat screw is a screw having a flat cylindrical shape, and a spiral groove portion extending from an outer periphery of the cylinder toward a central axis of the cylinder is formed in a bottom surface of the cylinder.

The barrel is provided with a third supply path. A heater is incorporated in the barrel. A temperature of the heater is controlled by the control device 60.

At least a part of a material supplied between the flat screw in rotation and the barrel is melted by heating of the heater incorporated in the barrel accompanying with rotation of the flat screw, and becomes the first material in a paste state having fluidity. The first material in a paste state is supplied to the first nozzle through the first communication hole provided in the barrel by the rotation of the flat screw. The first material supplied to the first nozzle is ejected, as the shaping material X, from the tip end of the first nozzle toward the stage 20.

The second material melting portion has the same configuration as the first material melting portion. Therefore, detailed description of the second material melting portion will be omitted below. The second material in a paste state in the second material melting portion is supplied to the second nozzle via the second communication hole provided in the barrel by the rotation of the flat screw. The second material supplied to the second nozzle is ejected, as the shaping material X, from the tip end of the second nozzle toward the stage 20.

Instead of such a configuration, the ejection portion 10 may be configured to selectively ejecting the first material and the second material as the shaping material X using a fused deposition modeling (FDM) method. In this case, the ejection portion 10 includes, for example, a first melting portion that melts filaments of the first material, a first extruder that ejects the filaments melted by the first melting portion, a second melting portion that melts filaments of the second material, and a second extruder that ejects the filaments melted by the second melting portion, instead of the nozzle Nz.

The moving portion 30 changes a relative position between the nozzle Nz of the ejection portion 10 and the stage 20. More specifically, the moving portion 30 changes the relative position between the nozzle Nz of the ejection portion 10 and the stage 20 by moving one or both of the ejection portion 10 and the stage 20. Hereinafter, a case in which the moving portion 30 changes the relative position between the nozzle Nz of the ejection portion 10 and the stage 20 by moving the stage 20 will be described as an example. For example, the moving portion 30 includes a first moving mechanism 31 that moves the ejection portion 10 along the Z axis, and a second moving mechanism 32 that moves the stage 20 along the X axis and the Y axis relative to the ejection portion 10. In the embodiment, the first moving mechanism 31 illustrated in FIG. 1 is implemented by an elevating device that moves the ejection portion 10 along the Z axis, and includes a motor for moving the ejection portion 10 along the Z axis. The second moving mechanism 32 illustrated in FIG. 1 is implemented by a horizontal conveyance device that moves the stage 20 along the X axis and the Y axis, and includes a motor for moving the stage 20 along the X axis and a motor for moving the stage 20 along the Y axis. The first moving mechanism 31 and the second moving mechanism 32 are controlled by the control device 60. The moving portion 30 may be configured to change the relative position between the temperature detection portion 50 to be described later and the stage 20 in addition to changing the relative position between the nozzle Nz of the ejection portion 10 and the stage 20. In this case, the moving portion 30 may be configured to not change the relative position between the nozzle Nz of the ejection portion 10 and the temperature detection portion 50, and may be configured to change the relative position between the nozzle Nz of the ejection portion 10 and the temperature detection portion 50. In the example illustrated in FIG. 1, the temperature detection portion 50 is provided in the ejection portion 10. Therefore, in this example, the moving portion 30 changes a relative position between the temperature detection portion 50 to be described later and the stage 20 in addition to changing the relative position between the nozzle Nz of the ejection portion 10 and the stage 20. In this example, the moving portion 30 does not change the relative position between the nozzle Nz of the ejection portion 10 and the temperature detection portion 50.

The heating portion 40 heats a target region including the shaping material X ejected from the ejection portion 10. Here, the target region is a region including all of the N slice layers L when the N slice layers L are stacked on the shaping surface 21 as one three-dimensional shaped object in a region on the shaping surface 21. The heating portion 40 may have any configuration as long as the heating portion 40 can heat the target region. In the example illustrated in FIG. 1, the heating portion 40 is a flat plate-shaped panel heater that has a surface facing an upper surface of the stage 20, that is, the shaping surface 21, and heats the target region. In this case, the heating portion 40 heats, as the target region, a region interposed between a lower surface of the heating portion 40 having a flat plate shape and the shaping surface 21. The heating portion 40 is controlled by the control device 60. In the example illustrated in FIG. 1, the heating portion 40 is provided with a through hole through which the nozzle Nz is inserted. Therefore, the heating portion 40 is provided around the nozzle Nz and moves together with the nozzle Nz. The heating portion 40 may be a heater of a chamber type for feeding warm air, a cartridge heater, or any other type of heater capable of heating the target region, instead of the panel heater. The three-dimensional shaping device 1 may not include the heating portion 40.

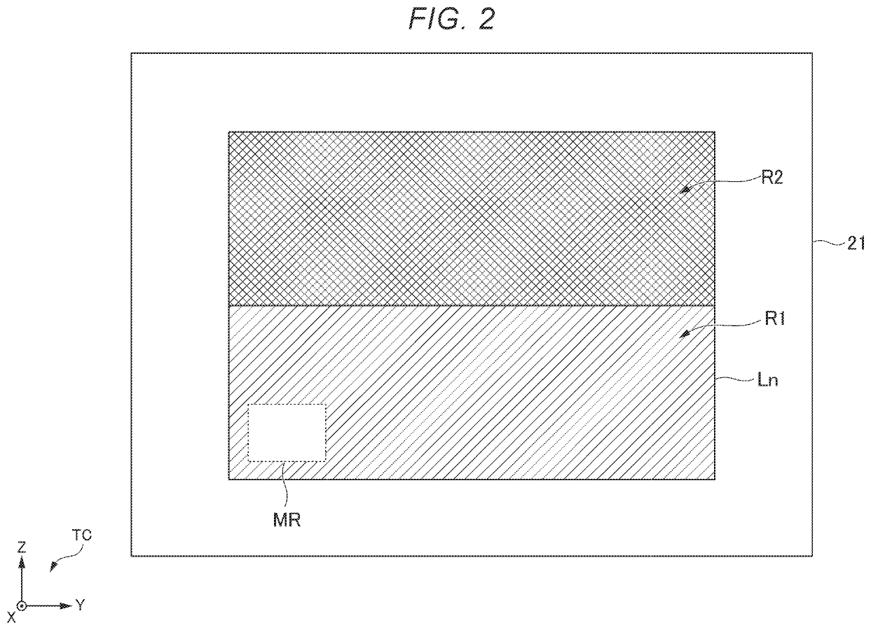

The temperature detection portion 50 is a temperature sensor that detects a temperature of a predetermined measurement region in a region on an upper surface of the slice layer L stacked on the shaping surface 21. That is, when the n-th slice layer Ln is stacked on the shaping surface 21, the temperature detection portion 50 detects a temperature of a predetermined measurement region of the n-th slice layer Ln. In this case, the temperature detection portion 50 may be any temperature sensor as long as the temperature detection portion 50 is a temperature sensor that can detect the temperature of the measurement region. Here, each of the N slice layers L includes a predetermined measurement region. FIG. 2 is a diagram illustrating an example of the predetermined measurement region of the n-th slice layer Ln. A region R1 indicated on the n-th slice layer Ln in FIG. 2 is an example of the above-described shaped region. A region R2 indicated on the n-th slice layer Ln in FIG. 2 is an example of the above-described support region. A region MR indicated in FIG. 2 is an example of the measurement region. As illustrated in FIG. 2, the measurement region is determined as a region included in the shaped region. The measurement region of the n-th slice layer Ln may be any region as long as a temperature of the region is likely to be close to an average temperature of the n-th slice layer Ln among regions included in the n-th slice layer Ln. Although a shape of the measurement region is a rectangular shape in the example illustrated in FIG. 2, the shape of the measurement region may be other shapes such as a circular shape or an elliptical shape. Outlines of the measurement regions of the N slice layers L may substantially overlap one another when the N slice layers L are viewed from the top to the bottom in a case where the N slice layers L are stacked on the shaping surface 21, except for a deviation due to a shaping error or the like. Outlines of some or all of the measurement regions of the N slice layers L may not overlap one another when the N slice layers L are viewed from the top to the bottom in a case where the N slice layers L are stacked on the shaping surface 21. Hereinafter, a case will be described as an example in which the outlines of the measurement regions of the N slice layers L substantially overlap one another when the N slice layers L are viewed from top to bottom in a case where the N slice layers L are stacked on the shaping surface 21, except for a deviation due to a shaping error or the like. In this case, the three-dimensional shaping data includes measurement region position information indicating a position of a measurement region on an XY plane. The XY plane is a virtual plane stretched by the X axis and the Y axis.

The temperature detection portion 50 is provided in the ejection portion 10 together with the heating portion 40. In the example illustrated in FIG. 1, the temperature detection portion 50 is provided on a lower surface of the heating portion 40. Therefore, a relative position between the temperature detection portion 50 and the ejection portion 10 do not change in the example. The temperature detection portion 50 outputs information indicating a detected temperature to the control device 60. The three-dimensional shaping device 1 may not include the temperature detection portion 50. In this case, the temperature detection portion 50 is communicably connected to the three-dimensional shaping device 1 from the outside. The temperature detection portion 50 may be a thermography camera and may be configured to detect a temperature of an object placed on the shaping surface 21 together with a temperature of the shaping surface 21 of the stage 20. When the n-th slice layer Ln is stacked on the shaping surface 21, the temperature detection portion 50 may be configured to detect a temperature of another region of the n-th slice layer Ln, instead of detecting the temperature of the predetermined measurement region of the n-th slice layer Ln.

The control device 60 controls the entire three-dimensional shaping device 1. The control device 60 acquires the three-dimensional shaping data generated by the data generation device 70 via a network or a recording medium. The control device 60 executes a three-dimensional shaping program stored in advance to execute shaping control for controlling operations of the ejection portion 10 and the moving portion 30 according to the three-dimensional shaping data, thereby shaping a three-dimensional shaped object. The control device 60 may not be implemented by a computer, and may be implemented by a combination of a plurality of circuits.

The shaping control described above is control executed for the ejection portion 10 and the moving portion 30. More specifically, the shaping control is control for shaping one three-dimensional shaped object having a predetermined shape by stacking the N slice layers L on the shaping surface 21. Here, the n-th slice layer Ln of the N slice layers L is stacked on the (n−1)-th slice layer L(n−1). At this time, when the n-th slice layer Ln is stacked on the (n−1)-th slice layer L(n−1), a part of the (n−1)-th slice layer L(n−1) is melted by heat of the n-th slice layer Ln. Therefore, the n-th slice layer Ln is joined with the (n−1)-th slice layer L(n−1). As a result, the N slice layers L are stacked on the shaping surface 21 as one three-dimensional shaped object. Therefore, a 0th slice layer L0 refers to the shaping surface 21 in the embodiment. That is, a first slice layer L1 is stacked on the 0th slice layer L0, that is, the shaping surface 21 in the embodiment.

When the n-th slice layer Ln is stacked on the (n−1)-th slice layer L(n−1) in the shaping control, the control device 60 controls the ejection portion 10 and the moving portion 30 and causes the ejection portion 10 to eject the shaping material X along the shaping path of the n-th slice layer VLn corresponding to the n-th slice layer Ln. Accordingly, the control device 60 can stack the n-th slice layer Ln on the (n−1)-th slice layer L(n−1). By performing the above-described control as the shaping control, the control device 60 sequentially ejects the shaping material X and stacks the N slice layers L on the shaping surface 21 to shape one three-dimensional shaped object.

In the shaping control, when the N slice layers L are stacked as the three-dimensional shaped object using the first material as the shaping material X without using the second material, the control device 60 executes the first stacking processing, and when the N slice layers L are stacked as the three-dimensional shaped object using the second material as the shaping material X without using the first material, the control device 60 executes the second stacking processing. Accordingly, the control device 60 can prevent an increase in a cycle time while preventing a decrease in interlayer adhesion.

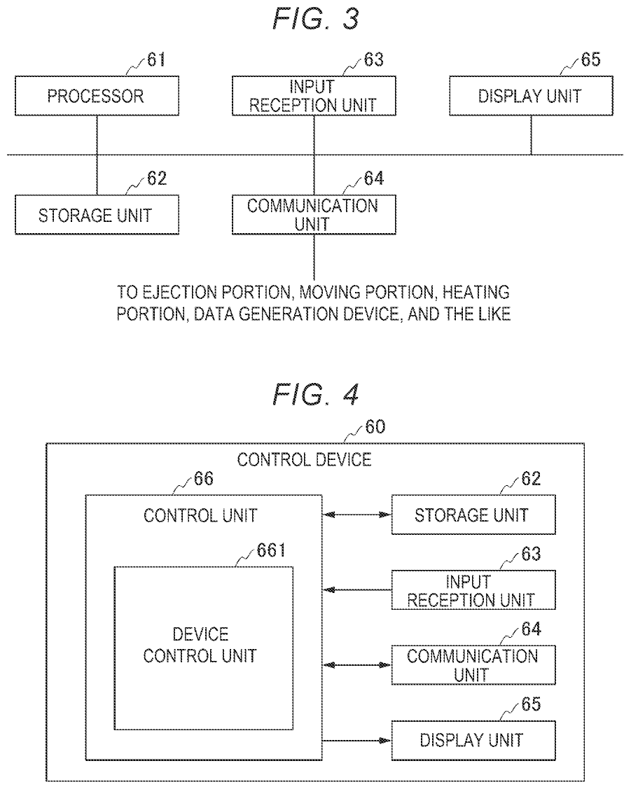

FIG. 3 is a diagram illustrating an example of a hardware configuration of the control device 60.

The control device 60 includes a processor 61, a storage unit 62, an input reception unit 63, a communication unit 64, and a display unit 65. As described above, the control device 60 may be an information processing device configured separately from the three-dimensional shaping device 1. In this case, the three-dimensional shaping device 1 is communicably connected to the information processing device and controlled by the information processing device.

The processor 61 is, for example, a central processing unit (CPU). The processor 61 may be other processors such as a field programmable gate array (FPGA). The processor 61 may include a plurality of processors. The processor 61 implements various functions of the control device 60 by executing various programs, various commands, and the like stored in the storage unit 62.

The storage unit 62 includes a hard disk drive (HDD), a solid state drive (SSD), an electrically erasable programmable read only memory (EEPROM), a read only memory (ROM), a random access memory (RAM), and the like. The storage unit 62 may be an external storage device coupled by a digital input and output port such as a universal serial bus (USB), instead of a configuration in which the storage unit 62 is incorporated in the control device 60. The storage unit 62 stores various programs, various commands, various kinds of information, and the like processed by the control device 60. For example, the storage unit 62 stores the three-dimensional shaping data and the like.

The input reception unit 63 receives an operation from a user when the user views an image displayed on the display unit 65. The input reception unit 63 is an input device including, for example, a keyboard, a mouse, and a touch pad. The input reception unit 63 may be a touch panel integrated with the display unit 65.

The communication unit 64 includes, for example, a digital input and output port such as a USB and an Ethernet (registered trademark) port.

The display unit 65 displays an image. The display unit 65 is a display provided in the control device 60, and is a display device including, for example, a liquid crystal display panel, and an organic electroluminescence (EL) display panel.

FIG. 4 is a diagram illustrating an example of a functional configuration of the control device 60.

The control device 60 includes the storage unit 62, the input reception unit 63, the communication unit 64, the display unit 65, and a control unit 66.

The control unit 66 controls the entire control device 60. The control unit 66 includes a device control unit 661. Functional units of the control unit 66 are implemented by, for example, the processor 61 executing various programs stored in the storage unit 62. Some or all of the functional units may be hardware functional units such as a large scale integration (LSI) and an application specific integrated circuit (ASIC).

The device control unit 661 controls the entire three-dimensional shaping device 1. For example, the device control unit 661 controls the ejection portion 10, the moving portion 30, and the heating portion 40.

The data generation device 70 is a device that generates three-dimensional shaping data used by the three-dimensional shaping device 1 to shape a three-dimensional shaped object. The data generation device 70 generates the three-dimensional shaping data using a method in which the three-dimensional shaping device 1 generates the three-dimensional shaping data as described above. Therefore, description of the method is omitted here. The data generation device 70 stores the shape data in response to a received operation. The data generation device 70 may be capable of generating the shape data or may not be capable of generating the shape data. When the data generation device 70 cannot generate the shape data, the data generation device 70 acquires the shape data from another device via a network or a storage medium. The data generation device 70 stores the slice condition information, the shaping path generation condition information, and the measurement region position information in response to a received operation.

The data generation device 70 is, for example, an information processing device such as a workstation, a desktop personal computer (PC), a notebook PC, a tablet PC, a multifunctional mobile phone terminal (smartphone), a mobile phone terminal, or a personal digital assistant (PDA), but is not limited thereto. More specifically, the data generation device 70 is implemented by a computer including one or more processors, a memory, and an input and output interface that inputs a signal from and output a signal to the outside.

Processing in which Control Device Executes Shaping Control

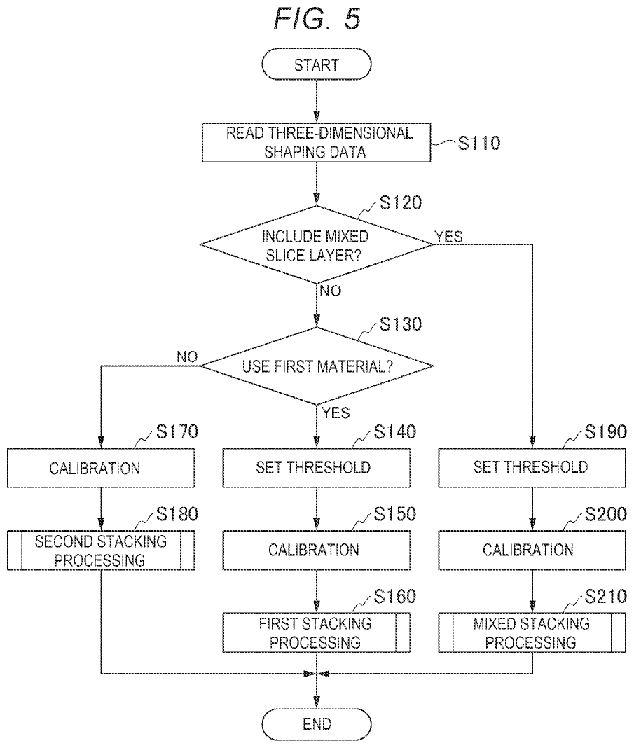

Hereinafter, processing in which the control device 60 executes shaping control will be described with reference to FIG. 5. FIG. 5 is a diagram illustrating an example of a flow of processing in which the control device 60 executes the shaping control. Hereinafter, a case where the three-dimensional shaping data is stored in the storage unit 62 at a timing before processing of step S110 illustrated in FIG. 5 is executed will be described as an example. Hereinafter, a case where the control device 60 receives an operation of causing the control device 60 to start the shaping control at the timing will be described as an example. Hereinafter, a case will be described as an example in which, when a determination result of step S120 to be described below is YES, at the timing, the control device 60 receives in advance an operation of causing the three-dimensional shaping device 1 to stack the N slice layers L as a three-dimensional shaped object using the first material as the shaping material X ejected to a shaped region and using the second material as the shaping material X ejected to a support region. Hereinafter, a case will be described as an example in which, when a determination result of step S130 to be described below is YES, at the timing, the control device 60 receives in advance an operation of causing the three-dimensional shaping device 1 to stack the N slice layers L as a three-dimensional shaped object using the first material as the shaping material X without using the second material as the shaping material X. Hereinafter, a case will be described as an example in which, when the determination result of step S130 to be described below is NO, at the timing, the control device 60 receives in advance an operation of causing the three-dimensional shaping device 1 to stack the N slice layers L as a three-dimensional shaped object using the second material as the shaping material X without using the first material as the shaping material X. Hereinafter, a case where target temperature information indicating a desired target temperature to be set as a threshold TH is received at the timing will be described as an example. When the control device 60 receives information indicating a type of a material accommodated in the first material supply portion, the control device 60 specifies whether the material accommodated in the first material supply portion is a crystalline resin or an amorphous resin based on information in which a type indicated by the information indicating the type of the material accommodated in the first material supply portion is associated with information indicating whether the material is a crystalline resin or an amorphous resin. In this case, the storage unit 62 of the control device 60 stores in advance the information in which the type indicated by the information indicating the type of the material accommodated in the first material supply portion is associated with the information indicating whether the material is a crystalline resin or an amorphous resin. The information may be information in a table format or information in other formats. When the control device 60 receives information indicating a type of a material accommodated in the second material supply portion, the control device 60 specifies whether the material accommodated in the second material supply portion is a crystalline resin or an amorphous resin based on information in which a type indicated by the information indicating the type of the material accommodated in the second material supply portion is associated with information indicating whether the material is a crystalline resin or an amorphous resin. In this case, the storage unit 62 of the control device 60 stores in advance the information in which the type indicated by the information indicating the type of the material accommodated in the second material supply portion is associated with the information indicating whether the material is a crystalline resin or an amorphous resin. The information may be information in a table format or information in other formats. Accordingly, the control device 60 can also specify which one or both of the first material and the second material are used as the shaping material X by receiving information indicating the type of the material accommodated in the first material supply portion.

After the control device 60 receives an operation of causing the control device 60 to start the shaping control, the device control unit 661 reads, from the storage unit 62, the three-dimensional shaping data stored in advance in the storage unit 62 (step S110).

Next, the device control unit 661 determines whether the above-described mixed slice layer is included in the N slice layers L based on the three-dimensional shaping data read in step S110 (step S120).

Next, when it is determined in step S120 that the mixed slice layer is not included in the N slice layers L (step S120—NO), the device control unit 661 determines whether the first material is used as the shaping material X based on an operation received in advance (step S130). The device control unit 661 may include a first reading unit and a second reading unit, and when the first material supply portion is the first material reservoir and the second material supply portion is the second material reservoir, the device control unit 661 may be configured to determine in step S130 whether to use the first material as the shaping material X based on identification information read from a material reservoir attached to the three-dimensional shaping device 1 between the first material reservoir and the second material reservoir. In this case, the storage unit 62 of the three-dimensional shaping device 1 stores in advance information in which identification information read by each of the first reading unit and the second reading unit is associated with the information indicating whether the material is a crystalline resin or an amorphous resin. The information may be information in a table format or information in other formats.

When it is determined in step S130 that the first material is used as the shaping material X (step S130—YES), the device control unit 661 sets a target temperature indicated by the target temperature information received in advance as the threshold TH (step S140). Here, the target temperature may be any temperature as long as the temperature is equal to or higher than a recrystallization temperature Tc of the crystalline resin contained in the first material and equal to or lower than a melting point Tm of the crystalline resin. In the three-dimensional shaping device 1, as the target temperature is close to the melting point Tm of the crystalline resin, interlayer adhesion between the N slice layers L can be increased. This is because when the n-th slice layer L is stacked on the (n−1)-th slice layer L(n−1) and a temperature of the (n−1)-th slice layer L(n−1) is a temperature near the melting point Tm, an upper surface of the (n−1)-th slice layer L(n−1) is easily dissolved due to a temperature of the n-th slice layer L. For example, when the first material is POM as in this example, the target temperature is a temperature in a range of 120° C. or more and 140° C. or less. Here, the device control unit 661 sets the target temperature indicated by target temperature information as the threshold TH by storing the target temperature as the threshold TH in the storage unit 62.

Next, the device control unit 661 performs calibration (step S150). The calibration in step S150 is calibration with regard to a relative height between the nozzle Nz and the stage 20, calibration with regard to a relative position between the nozzle Nz and the stage 20 in the XY plane, or the like. The calibration is not limited thereto, and may include other kinds of calibration. Since a method of performing the calibration is known, detailed description is omitted in the embodiment.

Next, the device control unit 661 executes the first stacking processing (step S160), and ends the processing in the flowchart illustrated in FIG. 5. Details of the first stacking processing will be described later.

On the other hand, when it is determined in step S130 that the first material is not used as the shaping material X (step S130—NO), the device control unit 661 determines that the second material is used as the shaping material X, and performs calibration (step S170). The processing of step S170 is the same as the processing of step S150. Therefore, detailed description of the processing of step S170 is omitted in the embodiment.

Next, the device control unit 661 executes the second stacking processing (step S180), and ends the processing in the flowchart illustrated in FIG. 5. Details of the second stacking processing will be described later.

On the other hand, when it is determined in step S120 that the mixed slice layer is included in the N slice layers L (step S120—YES), the device control unit 661 sets the target temperature indicated by the target temperature information received in advance as the threshold TH (step S190). The processing of step S190 is the same as the processing of step S140. Therefore, detailed description of the processing of step S190 is omitted in the embodiment.

Next, the device control unit 661 performs calibration (step S200). The processing of step S200 is the same as the processing of step S150. Therefore, detailed description of the processing of step S200 is omitted in the embodiment.

Next, the device control unit 661 executes a mixed stacking processing (step S210), and ends the processing in the flowchart illustrated in FIG. 5. Details of the mixed stacking processing will be described later.

According to the above flow, the control device 60 executes the shaping control. Accordingly, the control device 60 can prevent an increase in a cycle time while preventing a decrease in interlayer adhesion.

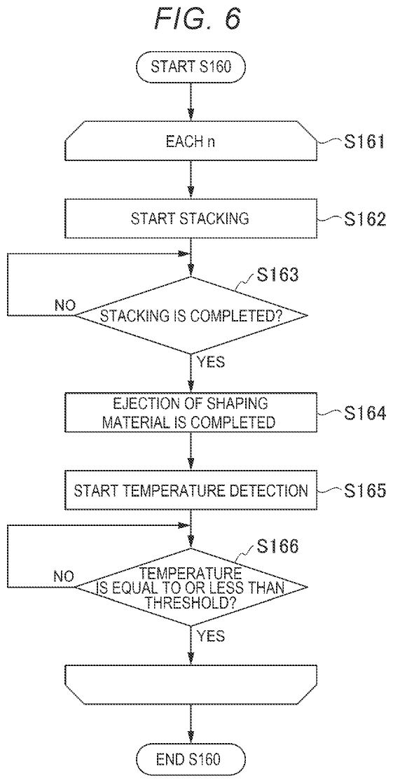

Next, the first stacking processing executed in step S160 illustrated in FIG. 5 will be described with reference to FIG. 6. FIG. 6 is a diagram illustrating an example of a flow of the first stacking processing executed in step S160 illustrated in FIG. 5.

After transitioning to step S160, the device control unit 661 selects the slice layers L one by one as a target slice layer in order from the first slice layer L to the N-th slice layer L, and repeatedly performs the processing of steps S162 to S166 for each selected target slice layer (step S161). In FIG. 6, the processing of step S161 is indicated by “each n”.

After selecting the target slice layer in step S161, the device control unit 661 controls the ejection portion 10 and the moving portion 30 based on the three-dimensional shaping data stored in advance in the storage unit 62, and starts stacking the selected target slice layer (step S162). A method of stacking the target slice layer based on the three-dimensional shaping data may be a known method or a method developed from the known method. Next, the device control unit 661 is in standby until the stacking of the target slice layer started in step S162 is completed (step S163). The processing of steps S161 to S162 are respective examples of the first slice layer forming processing and the second slice layer forming processing.

When it is determined in step S163 that the stacking of the target slice layer started in step S162 is completed (step S163—YES), the device control unit 661 causes the ejection portion 10 to stop the ejection of the shaping material X (step S164). The processing of step S164 is an example of the first ejection stop processing. During a period from when the ejection portion 10 stops the ejection of the shaping material X in step S164 to when a determination result of step S166 to be described below is YES, the device control unit 661 may perform an operation accompanying with the ejection of the shaping material X from the ejection portion 10 among operations different from the stacking of the target slice layer, such as cleaning of the ejection portion 10.

Next, the device control unit 661 refers to the measurement region position information stored in advance in the storage unit 62, and causes the temperature detection portion 50 to start detecting a temperature of a measurement region predetermined in the target slice layer (step S165).

Next, the device control unit 661 is in standby until the temperature detected by the temperature detection portion 50 in step S165 is equal to or less than the threshold TH (step S166). The processing of steps S165 to S166 are an example of the first temperature detection processing. In step S166, for example, the device control unit 661 may be configured to prevent a rapid decrease in the temperature of the target slice layer by setting the temperature of the heating portion 40 which is a panel heater to a temperature near the recrystallization temperature of the first material.

When the device control unit 661 determines that the temperature started to be detected by the temperature detection portion 50 in step S165 is equal to or less than the threshold TH (step S166—YES), the device control unit 661 transitions the processing to step S161 and selects a subsequent target slice layer. When there is no slice layer L to be selected as the target slice layer in step S161, the device control unit 661 ends the repetitive processing of steps S161 to S166, and ends the processing in the flowchart illustrated in FIG. 6, that is, the first stacking processing.

As described above, the first stacking processing includes the first slice layer forming processing, the first ejection stop processing, the first temperature detection processing, and the second slice layer forming processing. Accordingly, even when the three-dimensional shaped object is shaped by using the first material containing the crystalline resin, the three-dimensional shaping device 1 can prevent a decrease in interlayer adhesion.

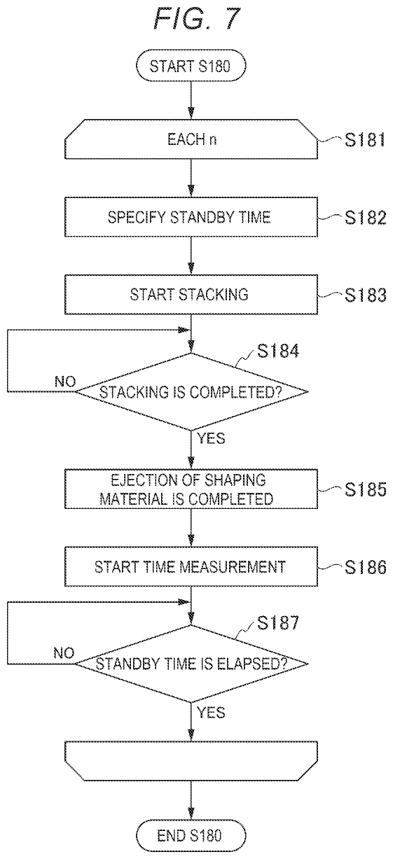

Next, the second stacking processing executed in step S180 illustrated in FIG. 5 will be described with reference to FIG. 7. FIG. 7 is a diagram illustrating an example of a flow of the second stacking processing executed in step S180 illustrated in FIG. 5.

After transitioning to step S180, the device control unit 661 selects the slice layers L one by one as a target slice layer in order from the first slice layer L to the N-th slice layer L, and repeatedly executes the processing of steps S182 to S187 for each selected target slice layer (step S181). In FIG. 7, the processing of step S181 is indicated by “each n”.

After selecting the target slice layer in step S181, the device control unit 661 calculates a time corresponding to a shape of the target slice layer as a standby time based on the three-dimensional shaping data stored in advance in the storage unit 62 (step S182). Here, the processing of step S182 will be described. For example, in step S182, the device control unit 661 specifies shaping path information indicating a shaping path of the target slice layer from shaping path information included in the three-dimensional shaping data. The device control unit 661 generates command data based on the specified shaping path information, and calculates a time required to stack the target slice layer as a shaping time of the target slice layer based on the generated command data. The device control unit 661 specifies a standby time corresponding to a shape of the target slice layer based on the calculated shaping time of the target slice layer and correspondence information stored in advance in the storage unit 62. A method of calculating the shaping time of the target slice layer based on the command data may be a known method or a method developed from the known method. Here, the correspondence information is information in which a shaping time and a standby time are associated with each other for each of a plurality of different shaping times. An individual shaping time included in the correspondence information is associated with a predetermined error range with the individual shaping time being a central value. Therefore, when the device control unit 661 specifies the standby time associated with a shaping time, the device control unit 661 specifies the shaping time having an error range including the shaping time from the correspondence information, and specifies the standby time associated with the specified shaping time from the correspondence information. The correspondence information may be information in a table format or information in other formats. The processing of step S182 is an example of standby time specifying processing.

Next, the device control unit 661 controls the ejection portion 10 and the moving portion 30 based on the three-dimensional shaping data stored in advance in the storage unit 62, and starts stacking the selected target slice layer (step S183). A method of stacking the target slice layer based on the three-dimensional shaping data may be a known method or a method developed from the known method.

Next, the device control unit 661 is in standby until the stacking of the target slice layer started in step S183 is completed (step S184). The processing of steps S183 to S184 are respective examples of the third slice layer forming processing and the fourth slice layer forming processing.

When it is determined in step S184 that the stacking of the target slice layer started in step S183 is completed (step S184—YES), the device control unit 661 causes the ejection portion 10 to stop the ejection of the shaping material X (step S185). The processing of step S185 is an example of the second ejection stop processing.

Next, the device control unit 661 starts measuring an elapsed time from a timing corresponding to the stop of the ejection of the shaping material X from the ejection portion 10 in step S185 (step S186). The timing may be a timing at which the ejection portion 10 stops the ejection of the shaping material X in step S185, or may be a timing after a predetermined time is elapsed from the timing at which the ejection portion 10 stops the ejection of the shaping material X in step S185. When the timing corresponding to the stop of the ejection of the shaping material X from the ejection portion 10 in step S185 is a timing after a predetermined time is elapsed from the timing at which the ejection portion 10 stops the ejection of the shaping material X in step S185, a cycle time can be shortened as the predetermined time is shortened.

Next, the device control unit 661 is in standby until the elapsed time measured in step S186 is equal to or longer than the standby time (step S187). The processing of steps S186 to S187 are examples of the first determination processing. During standby in step S187, the device control unit 661 may perform an operation accompanying with the ejection of the shaping material X from the ejection portion 10 among operations different from the stacking of the target slice layer, such as cleaning of the ejection portion 10.

When the device control unit 661 determines that the elapsed time measured in step S186 is equal to or longer than the standby time (step S187—YES), the device control unit 661 transitions the processing to step S181 and selects a subsequent target slice layer. When there is no slice layer L to be selected as the target slice layer in step S181, the device control unit 661 ends the repetitive processing of steps S181 to S187, and ends the processing in the flowchart illustrated in FIG. 7, that is, the second stacking processing.

In the three-dimensional shaping device 1, for example, when a shape of a three-dimensional shaped object to be shaped by the three-dimensional shaping device 1 is a predetermined shape, the standby time is determined such that a time from a time point at which the ejection portion 10 stops the ejection of the shaping material X in step S185 to a time point at which the processing of steps S183 to S184 is started next time is shorter than a time from a time point at which the ejection portion 10 stops the ejection of the shaping material X in step S164 to a time point at which the processing of steps S162 to S163 is started next time. Accordingly, the three-dimensional shaping device 1 prevents an increase in a cycle time. This can be achieved by, for example, shortening the standby time included in the correspondence information. In the three-dimensional shaping device 1, when the standby time is too short, unintended deformation may occur in the stacking of the slice layers L, and shaping accuracy of a three-dimensional shaped object may be lowered. Therefore, it is desirable to shorten the standby time included in the correspondence information to such an extent that unintended deformation does not occur in the stacking of the slice layers L by a preliminary experiment, simulation, or the like.

As described above, the second stacking processing includes the third slice layer forming processing, the second ejection stop processing, the first determination processing, and the fourth slice layer forming processing. Here, in the second stacking processing, a time from a timing when the (n−1)-th slice layer L(n−1) is stacked to a timing when the n-th slice layer L is stacked on the (n−1)-th slice layer L(n−1) is controlled by a standby time corresponding to a shape of the (n−1)-th slice layer L(n−1) in a different manner from the first stacking processing in which the time is controlled by the temperature of the (n−1)-th slice layer L(n−1). This can be achieved because a viscosity change of the second material corresponding to a temperature change within a range from the recrystallization temperature to the melting point is small. Accordingly, when a three-dimensional shaped object is shaped using the second material containing an amorphous resin, the three-dimensional shaping device 1 can prevent an increase in a cycle time while preventing a decrease in interlayer adhesion. That is, the three-dimensional shaping device 1 can prevent an increase in a cycle time while preventing a decrease in interlayer adhesion by switching between the first stacking processing and the second stacking processing according to whether a material to be used as the shaping material X is the first material or the second material.

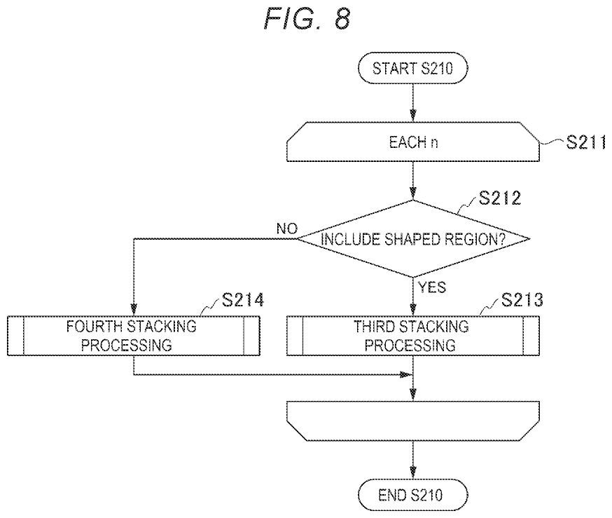

Next, the mixed stacking processing executed in step S210 illustrated in FIG. 5 will be described with reference to FIG. 8. FIG. 8 is a diagram illustrating an example of a flow of the mixed stacking processing executed in step S210 illustrated in FIG. 5.

After transitioning to step S210, the device control unit 661 selects the slice layers L one by one as a target slice layer in order from the first slice layer L to the N-th slice layer L, and repeatedly executes the processing of steps S212 to S214 for each selected target slice layer (step S211). In FIG. 8, the processing of step S181 is indicated by “each n”.

After selecting the target slice layer in step S211, the device control unit 661 determines whether a shaped region is included in the target slice layer based on the three-dimensional shaping data stored in advance in the storage unit 62 (step S212).

When it is determined that the shaped region is included in the target slice layer (step S212—YES), the device control unit 661 executes the third stacking processing (step S213), and then transitions the processing to step S211 and selects a subsequent target slice layer. When there is no slice layer L to be selected as the target slice layer in step S211, the device control unit 661 ends the repetitive processing of steps S211 to S214, and ends the processing in the flowchart illustrated in FIG. 8, that is, the mixed stacking processing. Details of the third stacking processing will be described later.

On the other hand, when the device control unit 661 determines that the shaped region is not included in the target slice layer (step S212—NO), the device control unit 661 executes the fourth stacking processing (step S214), and then transitions the processing to step S211 and selects a subsequent target slice layer. When there is no slice layer L to be selected as the target slice layer in step S211, the device control unit 661 ends the repetitive processing of steps S211 to S214, and ends the processing in the flowchart illustrated in FIG. 8, that is, the mixed stacking processing. Details of the fourth stacking processing will be described later.

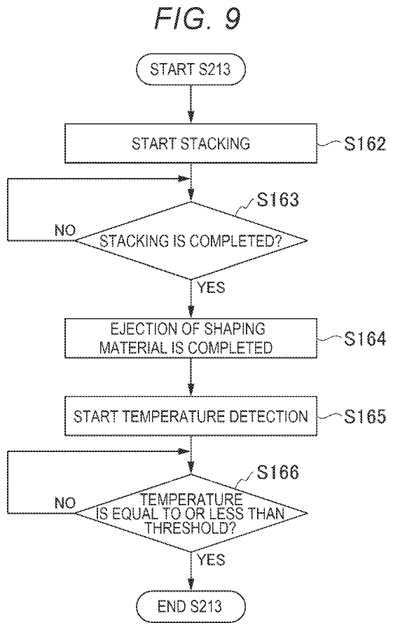

Next, the third stacking processing executed in step S213 illustrated in FIG. 8 will be described with reference to FIG. 9. FIG. 9 is a diagram illustrating an example of a flow of the third stacking processing executed in step S213 illustrated in FIG. 8.

As illustrated in FIG. 9, the third stacking processing is processing of executing the processing of steps S162 to S166 illustrated in FIG. 6. The processing of steps S162 to S166 illustrated in FIG. 9 is the same as the processing of steps S162 to S166 illustrated in FIG. 6. Therefore, detailed description of the processing of steps S162 to S166 illustrated in FIG. 9 is omitted in the embodiment.

When the shaped region is included in the target slice layer during the execution of the mixed stacking processing, the three-dimensional shaping device 1 can prevent shaping accuracy of a shaped body from being lowered by performing the third stacking processing as illustrated in FIG. 9 regardless of whether a support region is included in the target slice layer. For example, when both the shaped region and the support region are included in the target slice layer, the three-dimensional shaping device 1 can prevent shaping accuracy of the target slice layer from being lowered by stacking the shaped region before stacking the support region and then stacking the support region.

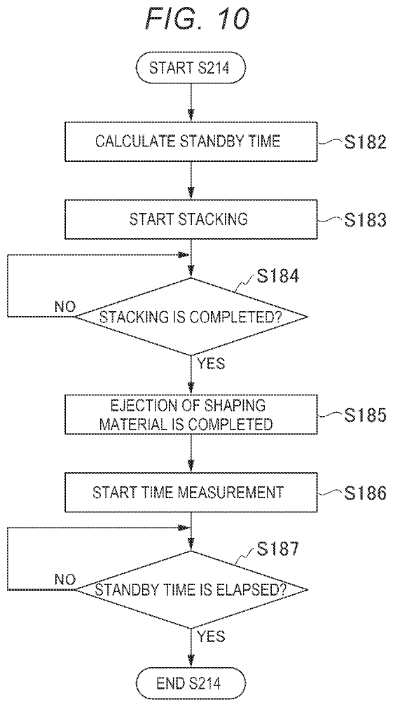

Next, the fourth stacking processing executed in step S214 illustrated in FIG. 8 will be described with reference to FIG. 10. FIG. 10 is a diagram illustrating an example of a flow of the fourth stacking processing executed in step S214 illustrated in FIG. 8.

As illustrated in FIG. 10, the fourth stacking processing is processing of executing the processing of steps S182 to S187 illustrated in FIG. 7. The processing of steps S182 to S187 illustrated in FIG. 9 is the same as the processing of steps S182 to S187 illustrated in FIG. 7. Therefore, detailed description of the processing of steps S182 to S187 illustrated in FIG. 9 is omitted in the embodiment.

When the shaped region is not included in the target slice layer during the execution of the mixed stacking processing, since the three-dimensional shaping device 1 stacks the target slice layer using the second material containing an amorphous resin without using the first material containing a crystalline resin, the three-dimensional shaping device 1 can prevent an increase in a cycle time while prevent a decrease in interlayer adhesion by executing the fourth stacking processing illustrated in FIG. 10.

The mixed stacking processing described above may be replaced with the first stacking processing.

In the mixed stacking processing described above, the three-dimensional shaping device 1 may be configured to execute the third stacking processing during the stacking of the shaped region and execute the fourth stacking processing during the stacking of the support region. That is, the three-dimensional shaping device 1 may be configured to switch a processing to be executed between the third stacking processing and the fourth stacking processing depending on which of the shaped region and the support region included in the target slice layer is to be stacked in the mixed stacking processing.

In the processing in which the control device 60 executes the shaping control as described above, the control device 60 automatically determines which of the first stacking processing, the second stacking processing, and the mixed stacking processing is to be executed by the three-dimensional shaping device 1. Alternatively, the control device 60 may be configured to receive information indicating which one of the first stacking processing, the second stacking processing, and the mixed stacking processing is to be executed by the three-dimensional shaping device 1 in the processing in which the control device 60 executes the shaping control, and execute one of the first stacking processing, the second stacking processing, and the mixed stacking processing based on the received information. That is, the control device 60 may be configured to manually switch the first stacking processing, the second stacking processing, and the mixed stacking processing. Similarly, the control device 60 may be configured to receive information indicating which one of the third stacking processing and the fourth stacking processing is to be executed by the three-dimensional shaping device 1 in the mixed stacking processing, and execute one of the third stacking processing and the fourth stacking processing based on the received information. That is, the control device 60 may be configured to manually switch between the third stack processing and the fourth stack processing.

### Predicted End Time Calculation Processing Executed by Control Device

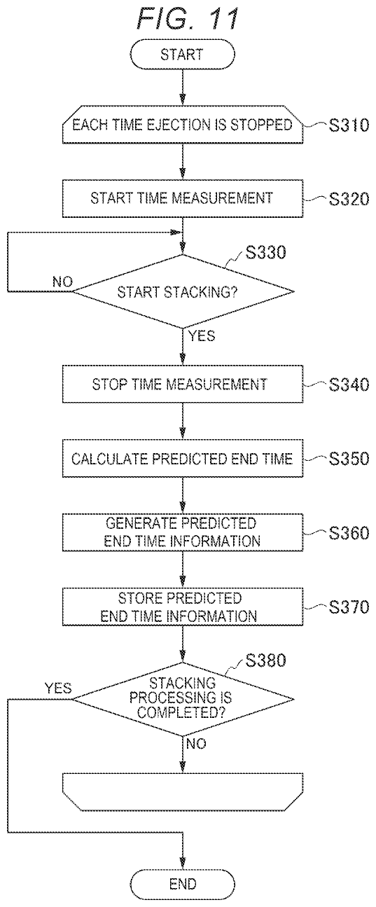

The control device 60 described above may be configured to execute a predicted end time calculation processing to be described below. FIG. 11 is a diagram illustrating an example of a flow of the predicted end time calculation processing executed by the control device 60. The predicted end time calculation processing is processing executed during the execution of each of the three pieces of stacking processing of the first stacking processing, the second stacking processing, and the mixed stacking processing described above. Hereinafter, for the convenience of description, the three pieces of stacking processing are collectively referred to as stacking processing unless it is necessary to distinguish the three pieces of stacking processing. The end time calculation processing is processing of calculating, as a predicted end time, a time predicted as a remaining time required until the stacking of the N slice layers L is completed in the stacking processing being executed by the control device 60. Therefore, the control device 60 repeatedly executes the processing in the flowchart illustrated in FIG. 11 each time the stacking processing is started. The control device 60 may be configured to repeatedly execute the processing in the flowchart illustrated in FIG. 11 each time a part of the repeatedly executed stacking processing is started.

After the stacking processing is started, the device control unit 661 repeatedly executes the processing of steps S320 to S380 each time the ejection portion 10 stops the ejection of the shaping material X (step S310).

After it is determined in step S310 that the ejection portion 10 stops the ejection of the shaping material X, the device control unit 661 starts measuring an elapsed time from a timing when it is determined in step S310 that the ejection portion 10 stops the ejection of the shaping material X (step S320).

Next, the device control unit 661 is in standby until stacking of the target slice layer by the ejection portion 10 is started (step S330). During the standby in step S330, when the shaping material X is ejected from the ejection portion 10 in an operation accompanying with the ejection of the shaping material X from the ejection portion 10 among operations different from the stacking of the target slice layer, such as cleaning of the ejection portion 10, the device control unit 661 determines that the stacking of the target slice layer by the ejection portion 10 is not started. Accordingly, the three-dimensional shaping device 1 can accurately calculate the predicted end time by the processing in the flowchart illustrated in FIG. 11 even when an operation accompanying with the ejection of the shaping material X from the ejection portion 10 among the operations different from the stacking of the target slice layer, such as cleaning of the ejection portion 10, is executed during the standby in step S330.

When it is determined in step S330 that the stacking of the target slice layer by the ejection portion 10 is started (step S330—YES), the device control unit 661 ends the time measurement started in step S320 (step S340). The processing of steps S320 to S340 are respective examples of first time measurement processing and second time measurement processing.

Next, the device control unit 661 calculates the predicted end time based on one or more elapsed times measured in the processing of steps S320 to S340 executed one or more times up to the present (step S350). For example, the device control unit 661 calculates an average value of one or more elapsed times measured in the processing of steps S320 to S340 executed one or more times up to the present, and calculates, as the predicted end time, a value obtained by multiplying the calculated average value by the number of remaining slice layers L that are not stacked to the upper side of the stage 20. The device control unit 661 may be configured to calculate the predicted end time using other methods.

Next, the device control unit 661 generates information indicating the predicted end time calculated in step S350 as predicted end time information (step S360).

Next, the device control unit 661 stores the predicted end time information generated in step S360 in the storage unit 62 (step S370).

Next, the device control unit 661 determines whether the stacking processing that triggers the start of the processing of step S310 is ended (step S380). The device control unit 661 may determine, using any method, whether the stacking processing that triggers the start of the processing of step S310 is ended.

When the device control unit 661 determines that the stacking processing that triggers the start of the processing of step S310 is not ended (step S380—NO), the device control unit 661 transitions the processing to step S310 and is in standby until the ejection portion 10 stops the ejection of the shaping material X.

On the other hand, when the device control unit 661 determines that the stacking processing that triggers the start of the processing of step S310 is ended (step S380—YES), the device control unit 661 ends the processing in the flowchart illustrated in FIG. 11, that is, the predicted end time calculation processing.

As described above, the control device 60 executes the predicted end time calculation processing of calculating the predicted end time as the remaining time required until the stacking of the N slice layers L is completed. The predicted end time calculation processing includes first time measurement processing, first end time storage processing, second time measurement processing, and second end time storage processing. The first time measurement processing is processing of measuring, as a first time measurement period, a time from the stop of the ejection of the shaping material X from the ejection portion 10 in the first ejection stop processing to the start of the second slice layer forming processing, each time the ejection of the shaping material X from the ejection portion 10 is stopped in the first ejection stop processing during the execution of the first stacking processing. The first end time storage processing is processing of calculating a first predicted end time as a predicted end time based on one or more of the first time measurement periods measured by the first time measurement processing up to the present and storing first predicted end time information indicating the calculated first predicted end time in the storage unit 62, each time a time is measured by the first time measurement processing during the execution of the first stacking processing. The second time measurement processing is processing of measuring, as a second time measurement period, a time from the stop of the ejection of the shaping material X from the ejection portion 10 in the second ejection stop processing to the start of the fourth slice layer forming processing, each time the ejection of the shaping material X from the ejection portion 10 is stopped in the second ejection stop processing during the execution of the second stacking processing. The second end time storage processing is processing of calculating a second predicted end time as a predicted end time based on one or more of the second time measurement periods measured by the second time measurement processing up to the present and storing second predicted end time information indicating the calculated second predicted end time in the storage unit 62, each time a time is measured by the second time measurement processing during the execution of the second stacking processing. Accordingly, the control device 60 can accurately notify a user of a remaining time required until the stacking of the N slice layers L is completed. As a result, the user can efficiently plan to start preparation for taking out the three-dimensional shaped object shaped by the three-dimensional shaping device 1 from the three-dimensional shaping device 1.

Contents described above may be freely combined.

As described above, the three-dimensional shaping device 1 is a three-dimensional shaping device that stacks N slice layers L as a three-dimensional shaped object having a predetermined shape. The three-dimensional shaping device 1 includes the stage 20, the ejection portion 10 configured to selectively eject, as a shaping material, the first material containing a crystalline resin and the second material containing an amorphous resin to an upper side of the stage 20, the moving portion 30 configured to relatively move the stage 20 and the ejection portion 10, and the control unit 66 configured to control the ejection portion 10 and the moving portion 30. The control unit 66 executes the first stacking processing when the N slice layers L are stacked as the three-dimensional shaped object using the first material as the shaping material X without using the second material, and executes the second stacking processing when the N slice layers L are stacked as the three-dimensional shaped object using the second material as the shaping material X without using the first material. The first stacking processing includes the first slice layer forming processing of controlling the ejection portion 10 and the moving portion 30 and stacking the (n−1)-th slice layer L(n−1) among the N slice layers to the upper side of the stage 20, the first ejection stop processing of causing the ejection portion 10 to stop the ejection of the shaping material X after the first slice layer forming processing is completed, the first temperature detection processing of causing the temperature detection portion 50 to detect a temperature of a measurement region of the (n−1)-th slice layer after the first ejection stop processing is completed, and the second slice layer forming processing of controlling the ejection portion 10 and the moving portion 30 and stacking the n-th slice layer among a plurality of slice layers to the upper side of the stage 20 when the temperature detected by the temperature detection portion 50 in the first temperature detection processing is equal to or less than the predetermined threshold TH. The second stacking processing includes the third slice layer forming processing of controlling the ejection portion 10 and the moving portion 30 and stacking the (n−1)-th slice layer L(n−1) to the upper side of the stage 20, the second ejection stop processing of causing the ejection portion 10 to stop the ejection of the shaping material X after the third slice layer forming processing is completed, the first determination processing of determining whether a predetermined standby time is elapsed from a first timing corresponding to the stop of the ejection of the shaping material X from the ejection portion 10 in the second ejection stop processing, and the fourth slice layer forming processing of controlling the ejection portion 10 and the moving portion 30 and stacking the n-th slice layer to the upper side of the stage 20 when it is determined in the first determination processing that the standby time is elapsed from the first timing. Accordingly, the three-dimensional shaping device 1 can prevent an increase in a cycle time while preventing a decrease in interlayer adhesion.

### APPENDIX

[1] A three-dimensional shaping device that stacks a plurality of slice layers as a three-dimensional shaped object having a predetermined shape, the three-dimensional shaping device including: a stage; an ejection portion configured to selectively eject, as a shaping material, a first material containing a crystalline resin and a second material containing an amorphous resin to an upper side of the stage; a moving portion configured to relatively move the stage and the ejection portion; and a control unit configured to control the ejection portion and the moving portion, in which the control unit executes first stacking processing when the plurality of slice layers are stacked as the three-dimensional shaped object using the first material as the shaping material without using the second material, and executes second stacking processing when the plurality of slice layers are stacked as the three-dimensional shaped object using the second material as the shaping material without using the first material, the first stacking processing includes first slice layer forming processing of controlling the ejection portion and the moving portion and stacking an (n−1)-th slice layer among the plurality of slice layers to the upper side of the stage, first ejection stop processing of causing the ejection portion to stop ejection of the shaping material after the first slice layer forming processing is completed, first temperature detection processing of causing a temperature detection portion to detect a temperature of a measurement region of the (n−1)-th slice layer after the first ejection stop processing is completed, and second slice layer forming processing of controlling the ejection portion and the moving portion and stacking an n-th slice layer among the plurality of slice layers to the upper side of the stage when the temperature detected by the temperature detection portion in the first temperature detection processing is equal to or less than a predetermined threshold, the second stacking processing includes third slice layer forming processing of controlling the ejection portion and the moving portion and stacking the (n−1)-th slice layer to the upper side of the stage, second ejection stop processing of causing the ejection portion to stop ejection of the shaping material after the third slice layer forming processing is completed, first determination processing of determining whether a predetermined standby time is elapsed from a first timing corresponding to a stop of the ejection of the shaping material from the ejection portion by the second ejection stop processing, and fourth slice layer forming processing of controlling the ejection portion and the moving portion and stacking the n-th slice layer to the upper side of the stage when it is determined in the first determination processing that the standby time is elapsed from the first timing, and n is an integer of 2 or more.
[2] The three-dimensional shaped object according to [1], in which when a shape of the three-dimensional shaped object is a first shape, a time from the stop of the ejection of the shaping material from the ejection portion by the second ejection stop processing to a start of the fourth slice layer forming processing is shorter than a time from a stop of the ejection of the shaping material from the ejection portion by the first ejection stop processing to a start of the second slice layer forming processing.
[3] The three-dimensional shaping device according to [1] or [2], further including: a material reservoir configured to store the shaping material in a solid state and having identification information for identifying the shaping material, in which the control unit reads the identification information provided in the material reservoir and determines whether the shaping material identified by the read identification information contains a crystalline resin.
[4] The three-dimensional shaping device according to any one of [1] to [3], in which the threshold is a temperature equal to or lower than a melting point of the first material and equal to or higher than a recrystallization temperature of the first material.
[5] The three-dimensional shaping device according to [4], in which the threshold is a temperature closer to the melting point of the first material than the recrystallization temperature of the first material.
[6] The three-dimensional shaping device according to any one of [1] to [5], in which each of the plurality of slice layers includes one or both of a shaped region included in a shaped body and a support region included in a support body, the control unit executes third stacking processing for stacking one or more first slice layers including the shaped region among the plurality of slice layers when the plurality of slice layers are stacked as the three-dimensional shaped object using the first material as the shaping material ejected to the shaped region and using the second material as the shaping material ejected to the support region, the third stacking processing includes fifth slice layer forming processing of controlling the ejection portion and the moving portion and stacking an (m−1)-th first slice layer among the one or more first slice layers to the upper side of the stage, third ejection stop processing of causing the ejection portion to stop ejection of the shaping material after the fifth slice layer forming processing is completed, second temperature detection processing of causing the temperature detection portion to detect a temperature of a measurement region of the (m−1)-th first slice layer after the third ejection stop processing is completed, and sixth slice layer forming processing of controlling the ejection portion and the moving portion and stacking an m-th first slice layer among the one or more first slice layers to the upper side of the stage when the temperature detected by the temperature detection portion in the second temperature detection processing is equal to or lower than the threshold, m is an integer of 2 or more, and a measurement region of each of the one or more first slice layers is included in the shaped region.
[7] The three-dimensional shaping device according to [6], in which the control unit executes fourth stacking processing for stacking one or more second slice layers not including the shaped region among the plurality of slice layers when the plurality of slice layers are stacked as the three-dimensional shaped object using the first material as the shaping material ejected to the shaped region and using the second material as the shaping material ejected to the support region, the fourth stacking processing includes seventh slice layer forming processing of controlling the ejection portion and the moving portion and stacking an (l−1)-th second slice layer among the one or more second slice layers to the upper side of the stage, fourth ejection stop processing of causing the ejection portion to stop ejection of the shaping material after the seventh slice layer forming processing is completed, second determination processing of determining whether the standby time is elapsed from a second timing corresponding to a stop of the ejection of the shaping material from the ejection portion by the fourth ejection stop processing, and eighth slice layer forming processing of controlling the ejection portion and the moving portion and stacking an l-th second slice layer among the one or more second slice layers to the upper side of the stage when it is determined in the second determination processing that the standby time is elapsed from the second timing, and l is an integer of 2 or more.
[8] The three-dimensional shaping device according to any one of [1] to [5], in which each of the plurality of slice layers includes one or both of a shaped region included in a shaped body and a support region included in a support body, and the control unit executes the first stacking processing when the plurality of slice layers are stacked as the three-dimensional shaped object using the first material as the shaping material ejected to the shaped region and using the second material as the shaping material ejected to the support region.
[9] The three-dimensional shaping device according to any one of [1] to [8], in which the control unit executes predicted end time calculation processing of calculating a predicted end time predicted as a remaining time required until stacking of the plurality of slice layers is completed, and the predicted end time calculation processing includes first time measurement processing of measuring, as a first time measurement period, a time from the stop of the ejection of the shaping material from the ejection portion by the first ejection stop processing to a start of the second slice layer forming processing, each time the ejection of the shaping material from the ejection portion is stopped by the first ejection stop processing during execution of the first stacking processing, first end time storage processing of calculating a first predicted end time as the predicted end time based on one or more of the first time measurement periods measured by the first time measurement processing up to the present and storing first predicted end time information indicating the calculated first predicted end time in a storage unit, each time a time is measured by the first time measurement processing during the execution of the first stacking processing, second time measurement processing of measuring, as a second time measurement period, a time from the stop of the ejection of the shaping material from the ejection portion by the second ejection stop processing to a start of the fourth slice layer forming processing, each time the ejection of the shaping material from the ejection portion is stopped by the second ejection stop processing during execution of the second stacking processing, and second end time storage processing of calculating a second predicted end time as the predicted end time based on one or more of the second time measurement periods measured by the second time measurement processing up to the present and storing second predicted end time information indicating the calculated second predicted end time in the storage unit, each time a time is measured by the second time measurement processing during the execution of the second stacking processing.
[10] The three-dimensional shaping device according to any one of [1] to [9], in which the second stacking processing includes standby time specifying processing of specifying a time corresponding to a shape of the (n−1)-th slice layer as the standby time.

Although the embodiment of the present disclosure has been described in detail with reference to the drawings, specific configurations are not limited to those in the embodiment, and modification, replacement, deletion, or the like may be performed without departing from the gist of the present disclosure.

A program for realizing a function of any component in a device described above may be recorded in a computer-readable recording medium, and the program may be read and executed by a computer system. Here, the device is, for example, the three-dimensional shaping device 1, the control device 60, and the data generation device 70. Here, the “computer system” includes an operating system (OS) and hardware such as a peripheral device. The “computer-readable recording medium” refers to a portable medium such as a flexible disk, a magneto-optical disk, a ROM, or a compact disk (CD)-ROM, or a storage device such as a hard disk incorporated in a computer system. Furthermore, the “computer-readable recording medium” includes a medium that stores a program for a certain period of time, such as a volatile memory inside a computer system serving as a server or a client when the program is transmitted via a network such as the Internet or a communication line such as a telephone line.

The program may be transmitted from a computer system in which the program is stored in a storage device or the like to another computer system via a transmission medium or transmission waves in a transmission medium. Here, the “transmission medium” that transmits the program refers to a medium having a function of transmitting information, for example, a network such as the Internet or a communication line such as a telephone line.

The above-described program may be program for implementing a part of the above-described functions. Further, the program may be a program capable of implementing the functions described above in combination with a program already recorded in the computer system, that is, a so-called differential file or a differential program.

What is claimed is:

1. A three-dimensional shaping device that stacks a plurality of slice layers as a three-dimensional shaped object having a predetermined shape, the three-dimensional shaping device comprising:
a stage;
an ejection portion configured to selectively eject, as a shaping material, a first material containing a crystalline resin and a second material containing an amorphous resin to an upper side of the stage;
a moving portion configured to relatively move the stage and the ejection portion; and
a control unit configured to control the ejection portion and the moving portion, wherein
the control unit executes first stacking processing when the plurality of slice layers are stacked as the three-dimensional shaped object using the first material as the shaping material without using the second material, and executes second stacking processing when the plurality of slice layers are stacked as the three-dimensional shaped object using the second material as the shaping material without using the first material,
the first stacking processing includes
first slice layer forming processing of controlling the ejection portion and the moving portion and stacking an (n−1)-th slice layer among the plurality of slice layers to the upper side of the stage,
first ejection stop processing of causing the ejection portion to stop ejection of the shaping material after the first slice layer forming processing is completed,
first temperature detection processing of causing a temperature detection portion to detect a temperature of a measurement region of the (n−1)-th slice layer after the first ejection stop processing is completed, and
second slice layer forming processing of controlling the ejection portion and the moving portion and stacking an n-th slice layer among the plurality of slice layers to the upper side of the stage when the temperature detected by the temperature detection portion in the first temperature detection processing is equal to or less than a predetermined threshold,
the second stacking processing includes
third slice layer forming processing of controlling the ejection portion and the moving portion and stacking the (n−1)-th slice layer to the upper side of the stage,
second ejection stop processing of causing the ejection portion to stop ejection of the shaping material after the third slice layer forming processing is completed,
first determination processing of determining whether a predetermined standby time is elapsed from a first timing corresponding to a stop of the ejection of the shaping material from the ejection portion by the second ejection stop processing, and
fourth slice layer forming processing of controlling the ejection portion and the moving portion and stacking the n-th slice layer to the upper side of the stage when it is determined in the first determination processing that the standby time is elapsed from the first timing, and
n is an integer of 2 or more.

2. The three-dimensional shaping device according to claim 1, wherein
when a shape of the three-dimensional shaped object is a first shape, a time from the stop of the ejection of the shaping material from the ejection portion by the second ejection stop processing to a start of the fourth slice layer forming processing is shorter than a time from a stop of the ejection of the shaping material from the ejection portion by the first ejection stop processing to a start of the second slice layer forming processing.

3. The three-dimensional shaping device according to claim 1, further comprising:
a material reservoir configured to store the shaping material in a solid state and having identification information for identifying the shaping material, wherein
the control unit reads the identification information provided in the material reservoir and determines whether the shaping material identified by the read identification information contains a crystalline resin.

4. The three-dimensional shaping device according to claim 1, wherein
the threshold is a temperature equal to or lower than a melting point of the first material and equal to or higher than a recrystallization temperature of the first material.

5. The three-dimensional shaping device according to claim 4, wherein
the threshold is a temperature closer to the melting point of the first material than the recrystallization temperature of the first material.

6. The three-dimensional shaping device according to claim 1, wherein
each of the plurality of slice layers includes one or both of a shaped region included in a shaped body and a support region included in a support body,
the control unit executes third stacking processing for stacking one or more first slice layers including the shaped region among the plurality of slice layers when the plurality of slice layers are stacked as the three-dimensional shaped object using the first material as the shaping material ejected to the shaped region and using the second material as the shaping material ejected to the support region,
the third stacking processing includes
fifth slice layer forming processing of controlling the ejection portion and the moving portion and stacking an (m−1)-th first slice layer among the one or more first slice layers to the upper side of the stage,
third ejection stop processing of causing the ejection portion to stop ejection of the shaping material after the fifth slice layer forming processing is completed,
second temperature detection processing of causing the temperature detection portion to detect a temperature of a measurement region of the (m−1)-th first slice layer after the third ejection stop processing is completed, and
sixth slice layer forming processing of controlling the ejection portion and the moving portion and stacking an m-th first slice layer among the one or more first slice layers to the upper side of the stage when the temperature detected by the temperature detection portion in the second temperature detection processing is equal to or lower than the threshold,
m is an integer of 2 or more, and
a measurement region of each of the one or more first slice layers is included in the shaped region.

7. The three-dimensional shaping device according to claim 6, wherein
the control unit executes fourth stacking processing for stacking one or more second slice layers not including the shaped region among the plurality of slice layers when the plurality of slice layers are stacked as the three-dimensional shaped object using the first material as the shaping material ejected to the shaped region and using the second material as the shaping material ejected to the support region,
the fourth stacking processing includes
seventh slice layer forming processing of controlling the ejection portion and the moving portion and stacking an (l−1)-th second slice layer among the one or more second slice layers to the upper side of the stage,
fourth ejection stop processing of causing the ejection portion to stop ejection of the shaping material after the seventh slice layer forming processing is completed,
second determination processing of determining whether the standby time is elapsed from a second timing corresponding to a stop of the ejection of the shaping material from the ejection portion by the fourth ejection stop processing, and
eighth slice layer forming processing of controlling the ejection portion and the moving portion and stacking an l-th second slice layer among the one or more second slice layers to the upper side of the stage when it is determined in the second determination processing that the standby time is elapsed from the second timing, and
l is an integer of 2 or more.

8. The three-dimensional shaping device according to claim 1, wherein
each of the plurality of slice layers includes one or both of a shaped region included in a shaped body and a support region included in a support body, and
the control unit executes the first stacking processing when the plurality of slice layers are stacked as the three-dimensional shaped object using the first material as the shaping material ejected to the shaped region and using the second material as the shaping material ejected to the support region.

9. The three-dimensional shaping device according to claim 1, wherein
the control unit executes predicted end time calculation processing of calculating a predicted end time predicted as a remaining time required until stacking of the plurality of slice layers is completed, and
the predicted end time calculation processing includes
first time measurement processing of measuring, as a first time measurement period, a time from the stop of the ejection of the shaping material from the ejection portion by the first ejection stop processing to a start of the second slice layer forming processing, each time the ejection of the shaping material from the ejection portion is stopped by the first ejection stop processing during execution of the first stacking processing,
first end time storage processing of calculating a first predicted end time as the predicted end time based on one or more of the first time measurement periods measured by the first time measurement processing up to the present and storing first predicted end time information indicating the calculated first predicted end time in a storage unit, each time a time is measured by the first time measurement processing during the execution of the first stacking processing,
second time measurement processing of measuring, as a second time measurement period, a time from the stop of the ejection of the shaping material from the ejection portion by the second ejection stop processing to a start of the fourth slice layer forming processing, each time the ejection of the shaping material from the ejection portion is stopped by the second ejection stop processing during execution of the second stacking processing, and
second end time storage processing of calculating a second predicted end time as the predicted end time based on one or more of the second time measurement periods measured by the second time measurement processing up to the present and storing second predicted end time information indicating the calculated second predicted end time in the storage unit, each time a time is measured by the second time measurement processing during the execution of the second stacking processing.

10. The three-dimensional shaping device according to claim 1, wherein
the second stacking processing includes standby time specifying processing of specifying a time corresponding to a shape of the (n−1)-th slice layer as the standby time.
